(19) United States
(12) Patent Application Publication
(10) Pub. No.: US 2007/0178720 A1
(43) Pub. Date: Aug. 2, 2007

(54) Electric Fan

(75) Inventor: Yusuke Yoshida, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, omitted

(73) Assignee: NIDEC CORPORATION, Kyoto (JP)

(21) Appl. No.: 11/669,172

(22) Filed: Jan. 31, 2007

(30) Foreign Application Priority Data
Jan. 31, 2006 (JP) JP-2006-23543

(51) Int. Cl. H01R 12/00

(52) U.S. Cl. 439/74

(57) ABSTRACT

An electric fan includes an impeller generating an air flow by its rotation, a motor rotating the impeller around a rotation axis, a circuit board with a driving circuit for the motor mounted thereon, and a housing. The housing accommodates the impeller, the motor, and the circuit board. A motor supporting portion of the housing, which supports the motor and the circuit board, includes a plate-like portion and an outer wall formed along an outer edge of the plate-like portion. The plate-like portion has at least one of a cutout portion formed on an outer edge thereof and a through hole formed therein. A reinforcement wall is formed along an outer edge of the through hole and/or the cutout portion.

### BACKGROUND OF THE INVENTION

1. Technical Field

The present invention relates to an electric fan.

2. Description of the Related Art

Electric fans including an impeller that generates an air flow by its rotation and a motor that rotates the impeller are often called as fan motors. Those electric fans are used in various devices such as personal computers, OA equipment, audio equipment, video equipment, and rice cookers. Each electric fan is attached to an outer case of the above device in order to cool the inside of the device. Electric fans can have various sizes in accordance with an object of use and are roughly classified into axial fans and centrifugal fans, for example.

In a general structure of the electric fans, an impeller, a motor, and a circuit board are accommodated in a resin housing which forms a passage for an air flow. A coil of a stator (armature) as a part of the motor and a motor driving circuit are mounted on the circuit board. A wiring harness (lead wires and a connector) for electrically connecting the circuit board to an external power supply, or the like, is connected to the circuit board (see Japanese Patent Laid-Open Application No. 2003-88037, for example).

FIG. 8 is a perspective view of a housing of an exemplary conventional electric fan, in which an outer frame of the housing is partially cut in order to facilitate visualization. FIG. 9 is a plan view of the housing of FIG. 8. The housing 101 includes the outer frame 102 having an approximately square outer periphery and an approximately circular inner periphery when seen in an axial direction parallel to a rotation axis of the electric fan. The housing 101 also includes a motor supporting portion 103 located at its center, which has an approximately circular shape when seen in the axial direction. Four ribs 104 connect the motor supporting portion 103 to the outer frame 102. A space between an inner peripheral surface of the outer frame 102 and an outer peripheral surface of the motor supporting portion 103 forms a passage for an air flow. In this passage, a plurality of blades of an impeller (not shown) which rotates to generate an air flow are located.

The motor supporting portion 103 includes a plate-like portion 105 in the form of an approximately circular plate, an outer peripheral wall 106 formed along an outer peripheral edge of the plate-like portion 105, and a hollow cylindrical portion 107 standing at a center of the plate-like portion 105. The outer peripheral wall 106 is provided for reinforcement, dust proofing, positioning of a circuit board, and the like. The cylindrical portion 107 holds a stator and a bearing of a motor. More specifically, the stator in which a coil is wound around a core is attached to an outer circumferential surface of the cylindrical portion 107, and the bearing (a ball bearing or a sliding bearing) is mounted inside the cylindrical portion 107. The impeller is secured to a shaft (not shown) which is held by the bearing, and rotates around the shaft.

A circuit board, in the form of a circular disk, for driving the motor is attached to the plate-like portion 105 of the motor supporting portion 103. At a center of the circuit board, a round hole is formed, into which the cylindrical portion 107 is to be inserted. The stator is directly attached to the circuit board. Electronic components, e.g., integrated circuits, chip resistors, and chip capacitors that form together a motor driving circuit, are mounted on the circuit board and are electrically connected to each other via a conductive pattern formed on the circuit board. The coil of the stator is also electrically connected to the conductive pattern.

A wiring harness (lead wires with a connector) for connecting the circuit board to an external power supply or the like is connected to the circuit board by soldering. A cutout portion 108 for ensuring a clearance or a space for the wiring harness or for allowing soldering of the wiring harness to the circuit board to be carried out therethrough is formed in an outer peripheral region of the plate-like portion 105. A wire holding portion 110 for holding the lead wires of the wiring harness is provided near the cutout portion 108 to project from one rib 104.

Moreover, it is proposed in accordance with new specifications of these kind of electric fans that a rewritable memory which stores therein data used for control of driving and rotation of the motor is mounted on the circuit board and the stored data can be rewritten from the outside. This can provide general-purpose electric fans applicable to a variety of applications. Rewriting of the stored data is carried out while a conductive pin (test pin) is in contact with a conductive land (test land) provided on the circuit board.

A substrate having copper foil on one side, which is inexpensive, is usually used as the circuit board. A surface with the copper foil formed thereon (pattern surface) faces the plate-like portion 105 of the motor supporting portion 103 shown in FIG. 8. Therefore, in order to bring the conductive pin into contact with the conductive land on the circuit board, it is necessary to form a through hole which allows for insertion of the conductive pin, in the plate-like portion 105 in advance.

### BRIEF SUMMARY OF THE INVENTION

According to an aspect of the present invention, an electric fan is provided. The electric fan includes: an impeller generating an air flow by its rotation; a motor driving the impeller to rotate; a circuit board with a driving circuit for the motor mounted thereon; and a housing supporting the motor and the circuit board and forming a passage for the air flow. The housing includes a motor supporting portion supporting the motor and the circuit board. The motor supporting portion includes a plate-like portion and an outer peripheral wall formed along an outer peripheral edge of the plate-like portion. The plate-like portion has at least one of a cutout portion formed on an outer peripheral edge thereof and a through hole formed therein. A reinforcement wall is formed along an outer peripheral edge of the at least one of the through hole and the cutout portion.

In an embodiment of the present invention, the cutout portion may be formed on the outer peripheral edge of the plate-like portion of the motor supporting portion of the housing. In this case, the cutout portion allows a wiring to be electrically connected to the circuit board from an outside of the electric fan.

In another embodiment of the present invention, the through hole may be formed in the plate-like portion of the motor supporting portion of the housing. In this case, the through hole prevents interference of an electronic component mounted on the circuit board with the plate-like portion.

In still another embodiment of the present invention, the through hole may be formed in the plate-like portion of the motor supporting portion of the housing. In this case, the through hole allows for insertion of a conductive pin to be brought into contact with a conductive land provided on the circuit board therethrough. In addition, the circuit board may include a rewritable memory which stores data for control of driving and rotation of the motor, and the conductive land may be used for rewriting the data stored in the rewritable memory from an outside of the electric fan by being brought into contact with the conductive pin.

In further another embodiment of the present invention, a height of the reinforcement wall may be lower than a height of the outer peripheral wall formed along the outer peripheral edge of the plate-like portion. In addition, a diameter of the circuit board may be slightly smaller than a diameter of an inner peripheral edge of the outer peripheral wall of the motor supporting portion of the housing.

According to preferred embodiments of the present invention, in an electric fan, at least one of a cutout portion and a through hole is formed in a plate-like portion of a motor supporting portion of a housing in order to facilitate electric connection of a wiring to a circuit board to be placed in the housing, mounting of a high (thick) component on the circuit board, contact of a test pin or the like with the circuit board, and a reinforcement wall is provided along an outer peripheral edge of the cutout portion or the through hole. Therefore, strength of the housing can be improved. Accordingly, the electric fan of the present invention can be used under severe environments of use.

Moreover, when the height of the reinforcement wall is made lower than the height of an outer peripheral wall formed along an outer peripheral edge of the plate-like portion, it is possible to firmly secure the circuit board by fitting the circuit board inside the outer peripheral wall.

Other features, elements, advantages and characteristics of the present invention will become more apparent from the following detailed description of preferred embodiments thereof with reference to the attached drawings.

### BRIEF DESCRIPTION OF THE SEVERAL VIEWS OF THE DRAWINGS

FIG. 1 is an exploded perspective view of a housing, a circuit board, and a stator of an electric fan according to a first preferred embodiment of the present invention.

FIG. 2 is a plan view of the housing of the electric fan of FIG. 1.

FIG. 3 is a cross-sectional view of the electric fan of FIG. 1.

FIG. 4 is a perspective view showing a state where the circuit board and the stator are mounted in the housing of the electric fan of FIG. 1.

FIG. 5 is a perspective view of a housing of an electric fan according to a second preferred embodiment of the present invention.

FIG. 6 is a perspective view showing a state where a circuit board and a stator are mounted in the housing of the electric fan of FIG. 5.

FIG. 7 is a perspective view of a housing of an electric fan according to a third preferred embodiment of the present invention.

FIG. 8 is a perspective view of a housing of an exemplary conventional electric fan.

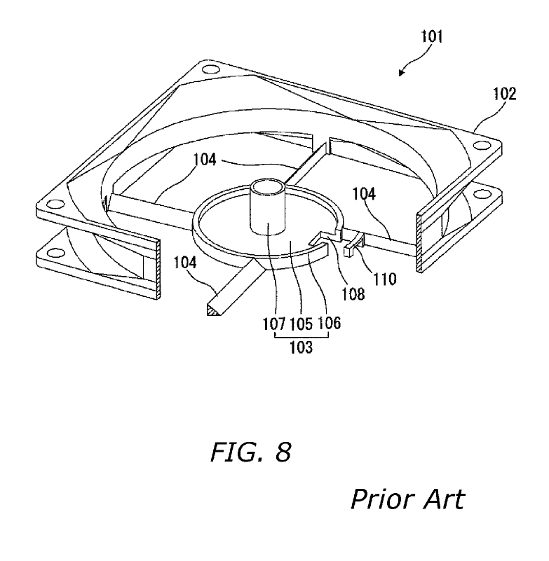

FIG. 9 is a plan view of the housing of the electric fan of FIG. 8.

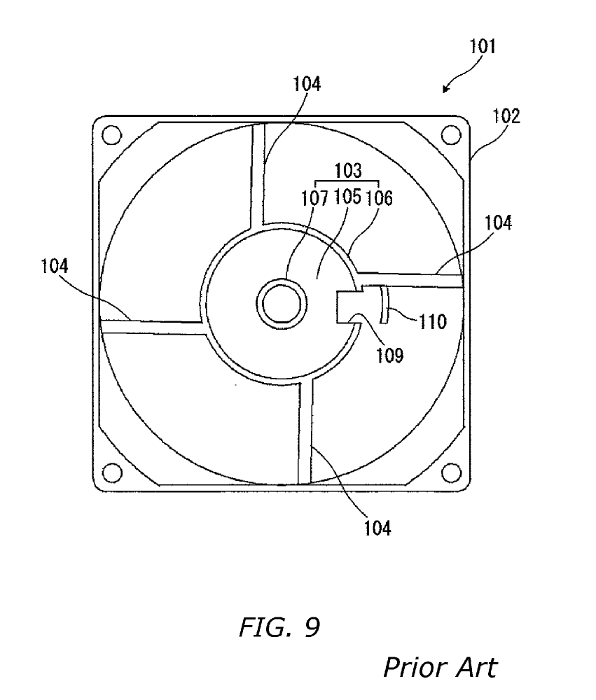

### DETAILED DESCRIPTION OF THE INVENTION

Recently demands for improvement of mechanical strength of electric fans under severe environment of use have been increased. In particular, in a case where an electric fan's housing including a motor supporting portion at its center is formed by resin molding, it is demanded that mechanical strength of the housing be made sufficiently high under environments in which a temperature changes largely and a large vibration or impact may be applied to the housing. The inventor of the present application made studies on how to improve the mechanical strength of such a housing, and found out that, when a cutout portion was formed in the motor supporting portion, stress applied to the housing and causing deformation of the housing tended to get concentrated on the cutout portion. Similarly, the inventor found out that, when a through hole for allowing a conductive pin to go through is formed in the motor supporting portion, the stress applied to the housing to cause deformation of the housing tended to get concentrated around the through hole, too. Based on the above findings, the inventor made the present invention by reinforcing the cutout portion or a portion around the through hole.

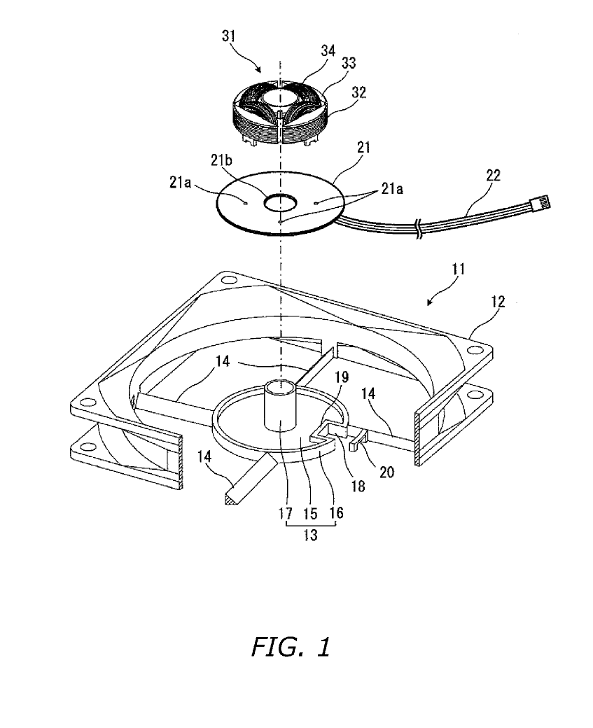

Preferred embodiments of the present invention are now described in detail, referring to FIGS. 1 through 7 in which like reference numerals identify like parts throughout the drawings to eliminate redundancy in description. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### First Preferred Embodiment

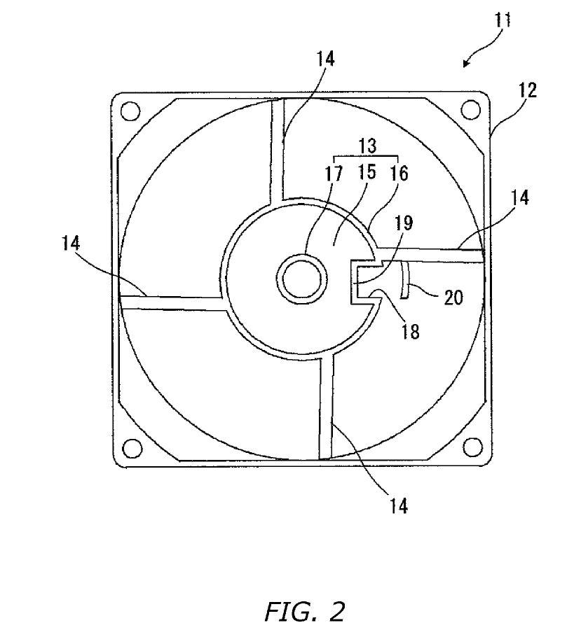

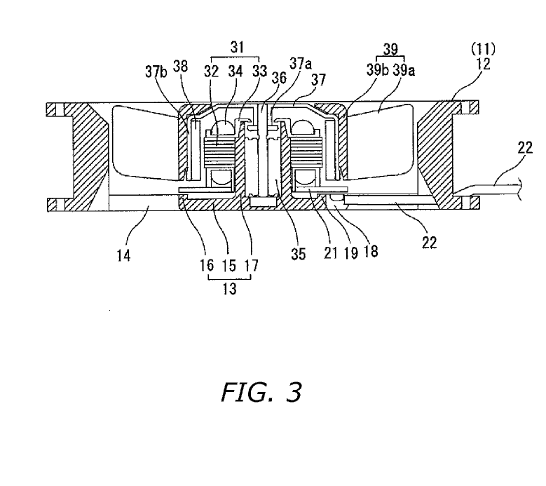

FIG. 1 is an exploded perspective view of a housing, a circuit board, and a stator of an electric fan according to a first preferred embodiment of the present invention. FIG. 2 is a plan view of the housing. FIG. 3 is a cross-sectional view of the electric fan of the first preferred embodiment. In FIG. 1, an outer frame 12 of the housing 11 is partially omitted for improving visualization.

As shown in FIGS. 1 and 3, the electric fan of the first preferred embodiment includes the housing 11, the circuit board 21 secured substantially at a center of the housing 11, and a stator (armature) 31 as a part of a motor. The housing 11 is formed of resin, and has an approximately square shape when seen in an axial direction parallel to a rotation axis of the electric fan. The circuit board 21 is formed of paper phenol resin with copper foil formed on one side. Moreover, as shown in FIG. 3, a shaft 36 as the rotation axis of the electric fan is held by a sliding bearing 35 which includes a sleeve formed of oil-retaining sintered alloy. An upper end of the shaft 36 is fitted into an inner cylindrical portion 37a of a metal rotor hub 37, so that an outer peripheral surface of the shaft 36 is secured to the inner cylindrical portion 37a.

A cylindrical rotor magnet 38 as a part of the motor is fitted and secured to an inner circumferential surface of an outer cylindrical portion 37b of the rotor hub 37. An inner circumferential surface of the rotor magnet 38 is opposed to an outer surface of a core 32 of the stator 31 with a predetermined gap interposed therebetween. A cylindrical portion 39b of an impeller 39 having a plurality of blades 39a is fitted and secured to an outer circumferential surface of the outer cylindrical portion 37b of the rotor hub 37. The impeller 39 is formed of resin.

As shown in FIGS. 1 and 2, the housing 11 includes an outer frame 12 having an approximately square outer periphery and an approximately circular inner periphery when seen in the axial direction, a motor supporting portion 13 which is arranged substantially at a center of the housing 11 and has an approximately circular shape when seen in the axial direction, and four supporting ribs 14 which connect the motor supporting portion 13 to the outer frame 12. The outer frame 12 and the motor supporting portion 13 are arranged with a space interposed therebetween. That space between an inner peripheral surface of the outer frame 12 and an outer peripheral surface of the motor supporting portion 13 forms a passage for an air flow. The blades 39a of the impeller 39 are arranged in this passage.

The motor supporting portion 13 includes a plate-like portion 15 in the form of an approximately circular plate, an outer peripheral wall 16 formed along an outer peripheral edge of the plate-like portion 15, and a hollow cylindrical portion 17 standing substantially at a center of the plate-like portion 15. The outer peripheral wall 16 is provided for reinforcement, dust proofing, positioning of the circuit board, and the like. The cylindrical portion 17 holds the stator 31 and the sliding bearing 35. More specifically, the stator 31 is attached to an outer circumferential surface of the cylindrical portion 17 and the sliding bearing 35 is arranged inside the cylindrical portion 17, as shown in FIG. 3.

Referring to FIG. 1, the stator 31 has a structure in which an insulator 33 formed of resin covers upper and lower ends of a core 32 having four teeth and a coil 34 is wound around each of the four teeth. Start and end of winding of the coil 34 are connected to terminal pins projecting downward from the insulator 33, respectively. The terminal pins penetrate through holes 21 a provided in the circuit board 21, and are electrically connected to a land in a copper foil pattern on a lower surface of the circuit board 21 by soldering and are secured on the lower surface of the circuit board 21. In this manner, the stator 31 as a part of the motor is attached and secured to the circuit board 21 directly.

The circuit board 21 is a substrate formed of paper phenol resin with copper foil formed on one side. A face on which the copper foil is formed (i.e., a pattern surface) is the lower surface of the circuit board 21, i.e., a surface facing the plate-like portion 15 of the motor supporting portion 13 of the housing 11. Surface mount electronic components such as integrated circuits (chip ICs), chip resistors, and chip capacitors which form together a driving circuit for the motor (stator 31), are mounted on the lower surface (pattern surface) of the circuit board 21 and are electrically connected to each other via a conductive pattern formed on the lower surface of the circuit board 21.

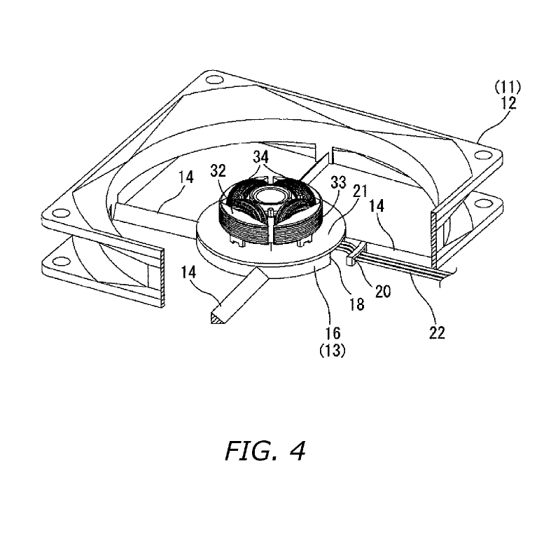

A through hole 21b is formed at a center of the circuit board 21. The circuit board 21 is attached to the motor supporting portion 13 of the housing 11 in such a manner that the cylindrical portion 17 of the housing 11 is inserted into the through hole 21b. Since the stator 31 as a part of the motor is attached and secured to the circuit board 21 directly as described above, the circuit board 21 is secured to the housing 11 via the stator 31 when the stator 31 is fitted and secured to the outer circumferential surface of the cylindrical portion 17 of the housing 11. FIG. 4 shows the housing 11 of the electric fan of the first preferred embodiment with the circuit board 21 and the stator 31 mounted thereon in a perspective view.

A wiring harness (lead wires with a connector) 22 used for connection to an external power supply or the like is connected to the circuit board 21 by soldering. In order to ensure a space or a clearance for receiving the wiring harness 22 or for allowing soldering of the wiring harness 22 to the circuit board 21 to be carried out therethrough, a cutout portion 18 is formed (on an outer edge) in the plate-like portion 15 of the motor supporting portion 13 of the housing 11. Moreover, a reinforcement wall 19 is formed along an outer peripheral edge of the cutout portion 18 in the housing 11 of the first preferred embodiment, as shown in FIGS. 1 and 2. This reinforcement wall 19 can prevent concentration of stress on the cutout portion 18 even when a vibration or an impact, or stress caused by a temperature change is applied to the housing 11, thus increasing mechanical strength of the housing 11.

FIG. 1 shows a manner of attachment of the circuit board 21 with the wiring harness 22 connected thereto in advance to the motor supporting portion 13 of the housing 11. In this case, the cutout portion 18 provides a space or a clearance which receives the wiring harness 22 (and a soldered portion of the circuit board 21 to which the wiring harness 22 is soldered). Alternatively, another assembly method may be employed in which the circuit board 21 with no wiring harness 22 is connected is attached to the motor supporting portion 13 and thereafter the wiring harness 22 is connected to a connection land on the circuit board 21 by soldering. In this case, the cutout portion 18 allows for connection of the circuit board 21 and the wiring harness 22 to each other by soldering. In the housing 11, a wire holding portion 20 which holds the lead wires of the wiring harness 22 is provided near the cutout portion 18 so as to project from one supporting rib 14, as shown in FIG. 1.

In the first preferred embodiment, a height of the reinforcement wall 19 formed along the outer edge of the cutout portion 18 is the same as that of the outer peripheral wall 16 formed along the outer edge of the plate-like portion 15. A diameter of the circuit board 21 is substantially the same as a diameter of the outer peripheral edge of the outer peripheral wall 16 of the motor supporting portion 13. In the assembled state shown in FIGS. 3 and 4, the lower surface of the circuit board 21 is in contact with upper surfaces of the outer peripheral wall 16 and reinforcement wall 19 or is opposed to those surfaces with a small gap interposed therebetween. The lower surface of the circuit board 21 can be fixed on the upper surfaces of the outer peripheral wall 16 and reinforcement wall 19 with adhesive or the like.

As described above, the reinforcement wall 19 is formed along the outer peripheral edge of the cutout portion 18 of the motor supporting portion 13 in the hosing 11 of the electric fan in the first preferred embodiment. Thus, mechanical strength of the motor supporting portion 13 increases. This increase in the mechanical strength of the motor supporting portion 13 contributes to reduction in the thickness of the plate-like portion 15 of the motor supporting portion 13. Therefore, it is possible to mount electronic components larger than those conventionally mounted on the lower surface of the circuit board 21. Moreover, the increase in the mechanical strength of the motor supporting portion 13 increases strength of the cylindrical portion 17 which holds the sliding bearing 35 against a force for causing the cylindrical portion 17 to fall. Thus, reliability of the electric fan is improved. Furthermore, the increase in the mechanical strength of the motor supporting portion 13 reduces the amount of deformation of the motor supporting portion 13 when an external force is applied to the motor supporting portion 13. Thus, concentration of stress on the supporting ribs 14 connecting the outer frame 12 of the housing 11 and the motor supporting portion 13 to each other can be suppressed.

In this embodiment, an example using the wiring harness 22 is described. However, wires with no connector may be used, instead of the wiring harness 22. In this case, the cutout portion 18 provides a space or a clearance for receiving the wires or allowing the wires to be electrically connected to the circuit board 21 from the outside of the fan.

### Second Preferred Embodiment

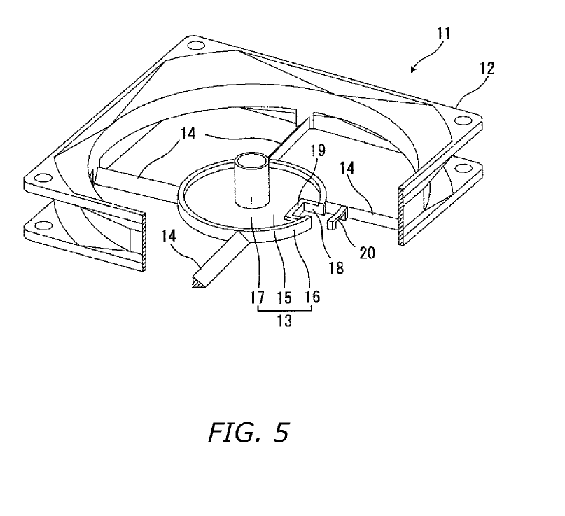

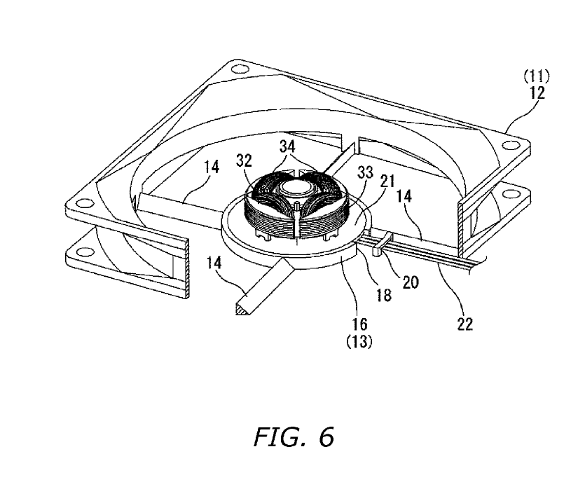

FIG. 5 is a perspective view of a housing of an electric fan according to a second preferred embodiment of the present invention. FIG. 6 shows the housing with a circuit board and a stator are mounted thereon. In the second preferred embodiment, the height of the reinforcement wall 19 formed along the outer peripheral edge of the cutout portion 18 is lower than the height of the outer peripheral wall 16 formed along the outer peripheral edge of the plate-like portion 15. In addition, the diameter of the circuit board 21 is slightly smaller than the diameter of the inner peripheral edge of the outer peripheral wall 16 of the motor supporting portion 13 of the housing 11. Therefore, the circuit board 21 can be fitted inside the outer peripheral wall 16.

In the second preferred embodiment, the reinforcement wall 19 is formed along the outer peripheral edge of the cutout portion 18, as in the first preferred embodiment. Therefore, concentration of stress on the cutout portion 18 when stress caused by a temperature change, or a vibration or an impact is applied to the housing 11 can be avoided, thus improving the mechanical strength. Moreover, since the circuit board 21 is mounted in such a manner that the circuit board 21 is fitted inside the outer peripheral wall 16 of the motor supporting portion 13, the circuit board 21 can be reliably fixed. In this case also, the lower surface and outer peripheral surface of the circuit board 21 may be fixed to the upper surface of the reinforcement wall 19 and the inner peripheral surface of the outer peripheral wall 16, respectively.

### Third Preferred Embodiment

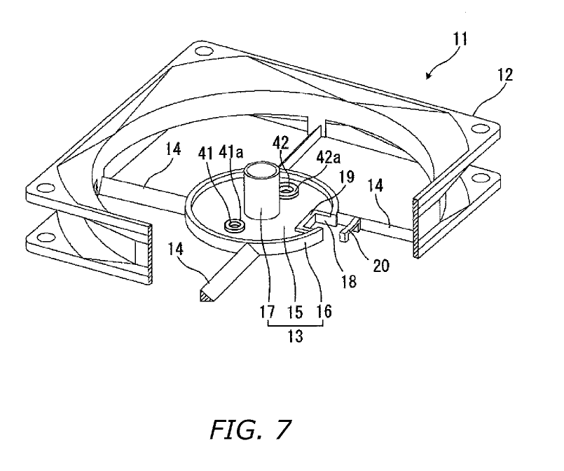

FIG. 7 is a perspective view of a housing of an electric fan according to a third preferred embodiment of the present invention. In the third preferred embodiment, through holes 41 and 42 are formed in the plate-like portion 15 of the motor supporting portion 13, and reinforcement walls 41a and 42a are formed along outer peripheral edges of the through holes 41 and 42, respectively. For example, a test pin is inserted through the through hole 41 during manufacturing or inspection of the electric fan. The through hole 42 is used for ensuring a space or a clearance in which a high (thick) electronic component is to be placed, i.e., avoiding interference of the electronic component on the circuit board 21 with the plate-like portion 15. Moreover, the through hole 42 may expose a top end of a thermistor temperature sensor mounted on the lower surface of the circuit board 21 to an outside air so that the thermistor temperature sensor is in direct contact with the outside air.

The through hole 41 through which the test pin is to be inserted is now described. In the electric fan of the third preferred embodiment, a rewritable memory which stores therein data (parameters) used for control of driving and rotation of the motor, i.e., control of an exciting current of the stator 31 is mounted on the circuit board 21. A plurality of different specifications can be achieved in a single electric fan by rewriting the data stored in the rewritable memory from the outside of the electric fan. That is, a general-purpose electric fan which can be used in a variety of applications can be achieved. Rewriting of data stored in the rewritable memory is carried out by bringing the test pin into contact with a test land (a portion in which copper foil is exposed) on the circuit board 21 during manufacturing or inspection of the electric fan.

As described above, a substrate with copper foil formed on one side, which is inexpensive, is used as the circuit board 21. A surface on which copper foil is formed (pattern surface) faces the plate-like portion 15 of the motor supporting portion 13. Therefore, it is possible to bring the test pin into contact with the test land on the circuit board 21 through the through hole 41 of the plate-like portion 15, so that the rewritable memory mounted on the circuit board 21 can be easily accessed from an external memory writing device for the purpose of rewriting the stored data. An operation for bringing the test pin into contact with the test land on the circuit board 21 can be carried out when a test apparatus, an adjustment apparatus and the like, as well as the memory writing device, have to access the circuit board 21.

In the housing 11 of the electric fan of the third preferred embodiment, in addition to the cutout portion 18 for allowing for connection of the wiring harness 22 to the circuit board 21, the through holes 41 and 42 for ensuring a space or a clearance in which a high (thick) electronic component can be placed to avoid interference with the plate-like portion 15 and for allowing for insertion of the test pin therethrough are formed in the plate-like portion 15 of the motor supporting portion 13. The reinforcement walls 41a and 42a are formed along the outer peripheral edges of the through holes 41 and 42, respectively. Therefore, concentration of stress around the through holes 41 and 42 can be suppressed, thus improving mechanical strength of the housing 11.

In the housing 11 of the electric fan of the third preferred embodiment, the height of the reinforcement walls 41a and 42a are the same as that of the reinforcement wall 19 around the cutout portion 18 but are lower than the height of the outer peripheral wall 16 formed along the outer peripheral edge of the plate-like portion 15. Therefore, by making the diameter of the circuit board 21 slightly smaller than the diameter of the inner peripheral edge of the outer peripheral wall 16 of the motor supporting portion 13 of the housing 11, the circuit board 21 can be mounted in the housing 11 in such a manner that the circuit board 21 is fitted inside the outer peripheral wall 16 of the motor supporting portion 13. In this case, the lower surface (pattern surface) of the circuit board 21 can be brought into contact not only with the upper surface of the reinforcement wall 19 along the cutout portion 18 but also with upper surfaces of the reinforcement walls 41a and 42a formed along the through holes 41 and 42, and can be bonded, if necessary. Therefore, it is possible to more firmly secure and hold the circuit board 21, as compared with the second preferred embodiment.

In a modified example of the third preferred embodiment, all the reinforcement walls 41a and 42a formed along the through holes 41 and 42, the reinforcement wall 19 formed along the cutout portion 18, and the outer peripheral wall 16 formed along the outer peripheral edge of the plate-like portion 15 may have the same height. In this case, the diameter of the circuit board 21 is made approximately the same as the diameter of the outer peripheral edge of the outer peripheral wall 16 of the motor supporting portion 13 of the housing 11, and the lower surface of the circuit board 21 is in contact with the upper surfaces of the outer peripheral wall 16 and reinforcement walls 19, 41a, and 42a or is opposed to those surfaces with a small gap interposed therebetween, as in the first preferred embodiment.

As described in the above embodiments and modified example, the present invention is carried out in various forms. For example, embodiments described below are possible.

Although the cutout portion 18 and the through holes 41 and 42 are formed in the motor supporting portion 13 of the housing 11 in the third preferred embodiment, the cutout portion 18 may be omitted so that only the through holes 41 and 42 are formed. Moreover, the numbers of the cutout portions and through holes is not limited to the numbers described in the above embodiments but can be changed to any numbers.

The above embodiments merely describe examples of specific structure, shape, material, and the like of the electric fan. The structure, shape, material, and the like of the electric fan can be modified in various ways. For example, the sliding bearing 35 may be replaced with a ball bearing. Moreover, the rotor hub 37 may be omitted so that the impeller 39 is fixed directly to the shaft 36. Furthermore, the present invention can be applied not only to axial fans described in the above embodiments but also to centrifugal fans.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. An electric fan comprising:
an impeller generating an air flow by its rotation;
a motor, to which the impeller is attached, rotating the impeller around a rotation axis;
a circuit board with a driving circuit for the motor mounted thereon; and
a housing accommodating the impeller, the motor, and the circuit board therein and surrounding the impeller to form a passage for the air flow between the housing and the impeller, wherein:
the housing includes a motor supporting portion opposed to the motor and supporting the motor and the circuit board;
the motor supporting portion includes a plate-like portion and an outer wall formed along an outer edge of the plate-like portion, the plate-like portion having at least one of a through hole formed therein and a cutout portion formed on an outer edge thereof; and
the housing includes a reinforcement wall formed along an outer edge of the at least one of the through hole and the cutout portion.

2. The electric fan according to claim 1, wherein the cutout portion is formed on the outer edge of the plate-like portion of the motor supporting portion of the housing, the cutout portion allowing a wire to be electrically connected to the circuit board from an outside of the electric fan.

3. The electric fan according to claim 1, wherein the through hole is formed in the plate-like portion of the motor supporting portion of the housing, the through hole preventing interference of an electronic component mounted on the circuit board with the plate-like portion.

4. The electric fan according to claim 1, wherein the through hole is formed in the plate-like portion of the motor supporting portion of the housing, the through hole allowing for insertion of a conductive pin which is to be brought into contact with a conductive land provided on the circuit board therethrough.

5. The electric fan according to claim 4, wherein the circuit board includes a rewritable memory which stores data used for control of driving and rotation of the motor, and the conductive land is used for rewriting the data stored in the rewritable memory from an outside of the electric fan by being brought into contact with the conductive pin.

6. The electric fan according to claim 1, wherein a height of the reinforcement wall is lower than a height of the outer wall formed along the outer edge of the plate-like portion.

7. The electric fan according to claim 1, wherein a diameter of the circuit board is slightly smaller than a diameter of an inner edge of the outer wall of the motor supporting portion of the housing.
